(19) United States
(12) Patent Application Publication
(10) Pub. No.: US 2026/0020709 A1
(43) Pub. Date: Jan. 22, 2026

(54) CREAM SPREAD WITH DETACHABLE DROPPER

(71) Applicants: Momo NOGAMI, Saitama Pref. (JP); Zizhuo GUO, Tokyo (JP); Hinano ISHIKAWA, Tokyo (JP); Nan WU, Fujian Province (CN)

(72) Inventors: Momo NOGAMI, Saitama Pref. (JP); Zizhuo GUO, Tokyo (JP); Hinano ISHIKAWA, Tokyo (JP); Nan WU, Fujian Province (CN)

(21) Appl. No.: 19/340,914

(22) Filed: Sep. 26, 2025

(51) Int. Cl. A47J 9/00; A47J 43/28

(52) U.S. Cl. CPC A47J 9/001; A47J 43/288

(57) ABSTRACT

A cream spread includes a blade including a sharp edge, a flat side surface, and a first cavity, said blade having a plurality of through-holes on the side surface connected to the first cavity, and an opening at one end; a handle detachably connected to the blade at the side surface, the handle including an internal a second cavity, and a first opening and a second opening, each of which is connecting to the second cavity, wherein the handle is formed of elastic material; and a dropper including a first region to be inserted into the blade, and a second region to be disposed within the handle, wherein the first region protrudes from the first opening of the handle when installed in the handle.

### BACKGROUND OF THE INVENTION

### 1. Field of the Invention

The present invention relates to a spread including a blade and a handle, and more particularly, to a cream spread having a dropper located in the handle.

### 2. Description of the Related Art

Generally, when spreading cream to white bread or sponge cake (hereinafter collectively referred to as “bread”), a bread knife is initially used to cut the bread into a desired size. Subsequently, a cream dispenser is employed to apply cream onto the bread, and the bread knife or similar tool is utilized to spread the cream into a uniform thickness.

However, conventional bread knives, because of their shape, makes it difficult to spread the cream to an even thickness, requiring the use of a butter knife or similar tool in addition to the bread knife. Therefore, the bread knife, cream dispenser, and butter knife had to be cleaned after use, which was a very time-consuming and labor-intensive task.

### SUMMARY OF THE INVENTION

The objective of the present invention is to resolve the aforementioned issues by providing a cream spread includes a blade, which includes a sharp edge, a flat side surface, and a first cavity, said blade having a plurality of through-holes on the side surface connected to the first cavity, and an opening at one end; a handle detachably connected to the blade at the side surface, the handle including an internal a second cavity, and a first opening and a second opening, each of which is connecting to the second cavity, wherein the handle is formed of elastic material; and a dropper including a first region to be inserted into the blade, and a second region to be disposed within the handle, wherein the first region protrudes from the first opening of the handle when installed in the handle.

### BRIEF DESCRIPTION OF THE DRAWINGS

The invention is described in detail with reference to the accompanying drawings:

FIG. 1 shows a perspective view of a cream spread of the present invention;

FIG. 2A shows the first side view of a handle used in the cream spread of the present invention;

FIG. 2B shows the second side view of the handle used in the cream spread of the present invention;

FIG. 3A shows the first side view of a blade used in the cream spread of the present invention;

FIG. 3B shows the second side view of the blade used in the cream spread of the present invention;

FIG. 4 shows the third side view of the handle of the cream spread when a dropper is attached;

FIG. 5A shows an enlarged view of the handle of the cream spread of the present invention; and

FIG. 5B shows a cross-sectional view of the handle of the cream spread of the present invention.

### DETAILED DESCRIPTION OF THE PREFERRED EMBODIMENTS

Preferred embodiments of the present invention are described below with reference to the drawings. In each drawing, the same reference numerals indicate the same or similar components passing through all the embodiments.

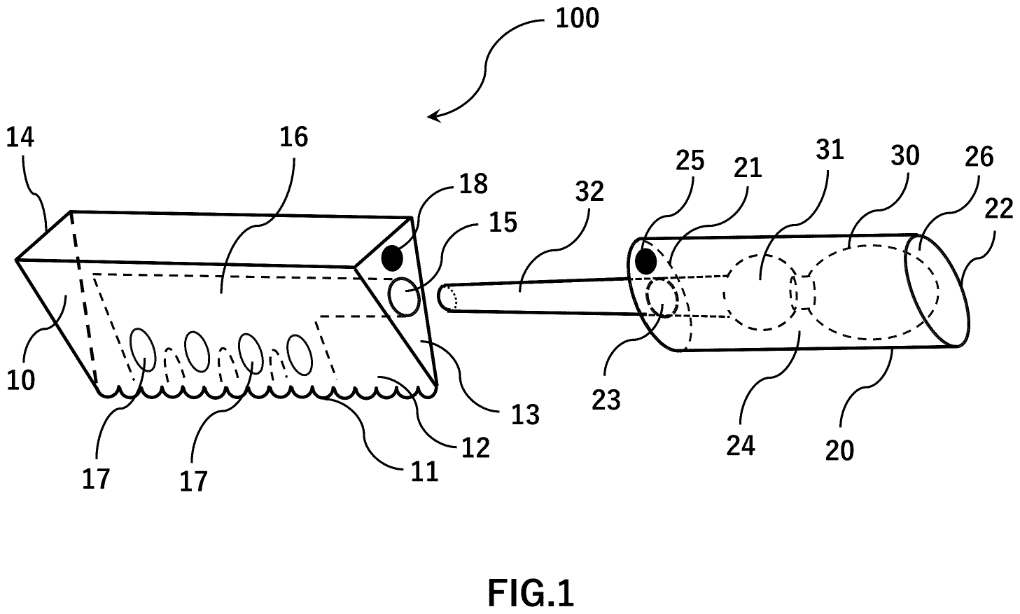

FIG. 1 shows a perspective view of a cream spread of the present invention. As illustrated in FIG. 1, the cream spread 100 includes a blade 10, a handle 20, and a detachable dropper 30 inserted into the handle 20.

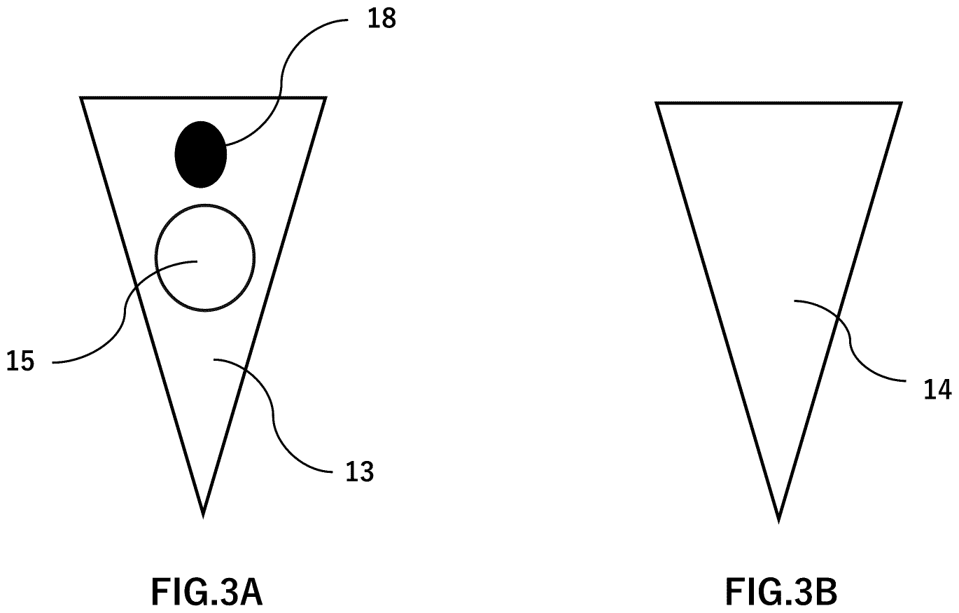

FIG. 3A and FIG. 3B show the first and second side views of a blade 10 used in the cream spread 100. As shown in FIGS. 1, 3A and 3B, the blade 10 includes a sharp edge 11 and a flat side 12. A cavity 16 having an opening 15 being formed on a first side 13 of the blade 10 is formed in the blade 10. Further, four (4) through-holes 17, each of which is connected to the cavity 16, are formed on the surface of the flat side 12. A first magnet 18 having S-pole is embedded on the first side 13 of the blade 10. A second side 14 of the blade 10 opposite the first side 13 is flat, as shown in FIG. 3B.

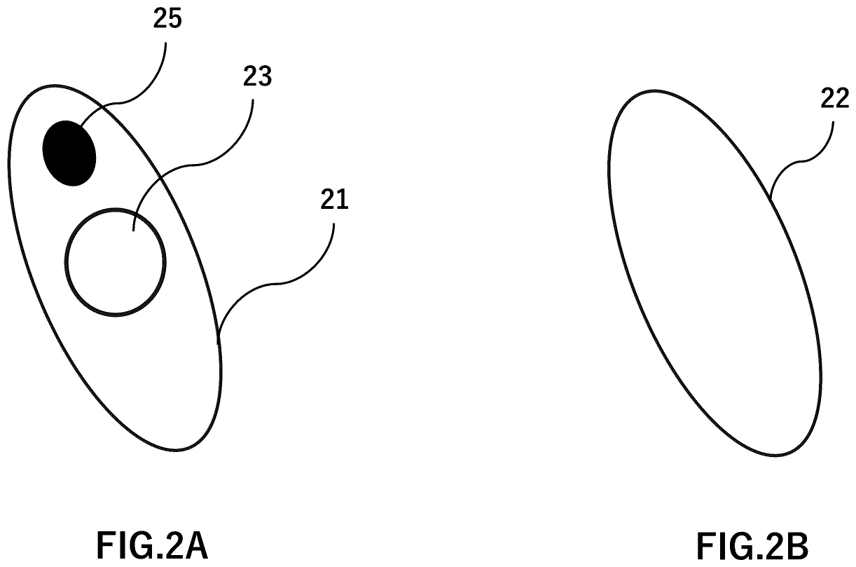

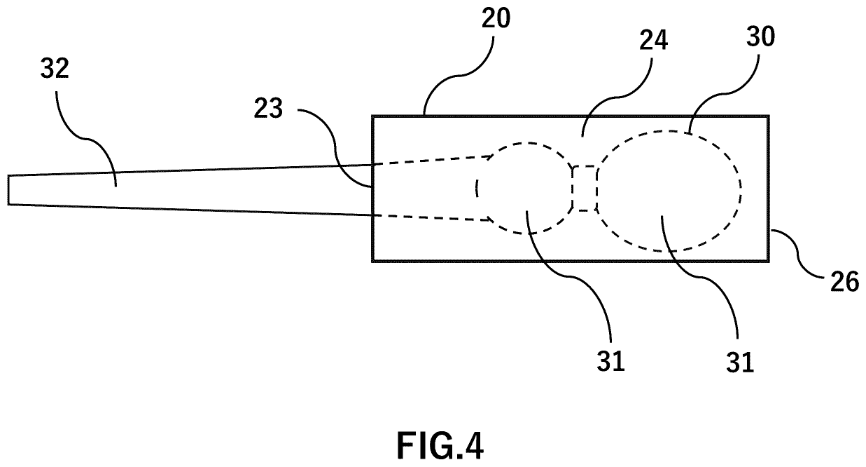

FIGS. 2A and 2B show the first and second side views of the handle 20 used in the cream spread 100. As shown in FIG. 1 and FIGS. 2A and 2B, the handle 20 includes cavity 24 (illustrated in FIG. 4) having a first opening 23 being formed on a first side 21. A second magnet 25 having N-pole is disposed on the first side 21 adjacent to the first opening and being faced to the first magnet 18. A second opening 26 is formed on the second side 22 opposite the first side 21. The handle 20 is made of an elastic material (e.g., silicone rubber). With this configuration, the blade 10 and the handle 20 are detachably coupled to each other by the first and second magnets 18, 25.

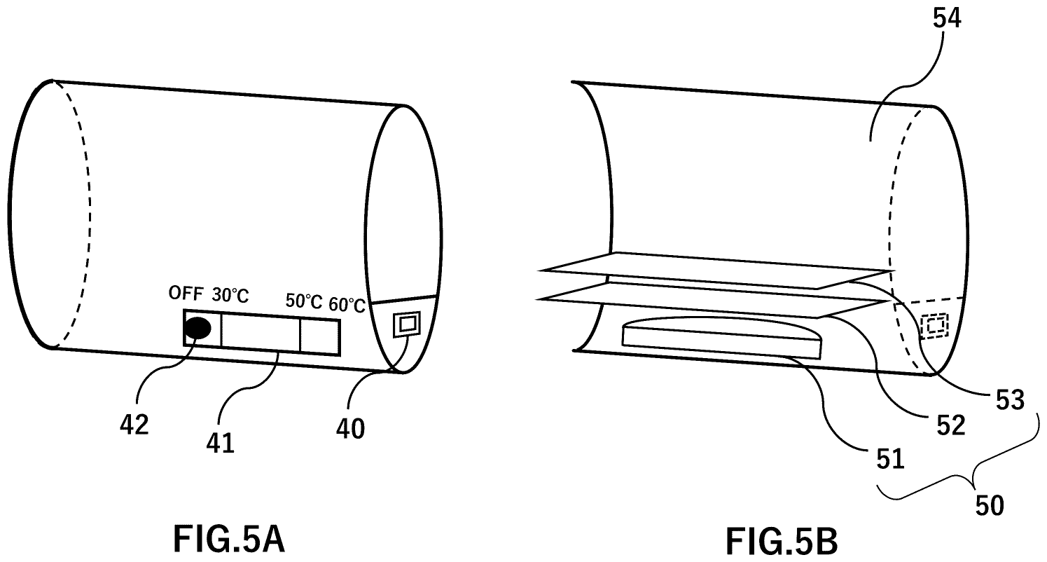

As shown in FIGS. 5A and 5B, the handle 20 further includes a heating unit 50. The heating unit 50 includes a PTC heating plate 53, a thermally conductive copper plate 52, an insulating layer 54 formed on the inner surface of the case, a temperature display panel 41, and a 3.7V lithium battery 51. A heating slide button (touch or mechanical) 42, which functions as a meter showing the current temperature, and a charging port (USB-C or magnetic) 40 are also formed on the surface of the handle 20. The heating unit 50 controls temperature between 30 to 60 Celsius for softening butter, jam, or cream, which is stored in a dropper 30 (illustrated in FIG. 1 and FIG. 4) for spreading it smoothly.

FIG. 4 shows the third side view of the handle 20 of the cream spread 100 when a dropper is attached. As shown in FIGS. 1 and 4, the dropper 30 has a first region 31, which is positioned within the cavity 24 and a second region 32 which is exposed from the first opening 23 when the dropper 30 is installed in the handle 20. The dropper 30 is inserted into the handle 20 via a second opening 26 opposite to the first opening 23, and is made of elastic material, such as polyethylene. When using the cream spread 100, the second region 32 of the dripper 30 is inserted into the blade 10 through the opening 15 of the blade 10, so that by designed the diameter of the opening 15 on the first side 13 of the blade 10 and the diameter of the second region 32 of the dripper 30 located at the first opening 23 of the handle 20 are identical, the second region 32 of the dripper 30 can be completely inserted within the cavity 16 of the blade 10. At that time, the coupling of the first and second magnets 18, 25 creates a strong connection between the blade 10 and the handle 20.

The cream spread 100 formed as described above is used as follows. First, before using the cream spread 100, the dropper 30 filled with cream is inserted into the handle 20. More particularly, the second region 32 of the dropper 30 is inserted through the second opening 26 into the handle 20 until the second region 32 protrudes from the first opening 23 of the handle 20 completely. As a result, the dropper 30 is placed within the handle 20. At this stage, the first region 31 of the dropper 30 is adjusted to ensure that it fits within the cavity 24 of the handle 20.

Next, the blade 10 is attached to the handle 20. The second region 32 of the dripper 30 is inserted into the cavity 16 via the opening 15 of the blade 10. At this stage, the second region 32 of the dropper 30 is entirely fit within the cavity 16 of the blade 10. As the result, the blade 10 and handle 20 become one piece. Simultaneously, as mentioned above, the first magnet 18 on the blade 10 and the second magnet 25 on the handle 20 are magnetically attracted, establishing a stable connection.

Subsequently, since the cream spread 100 has a shape edge 11, using the cream spread 100, slice white bread into desired sizes. During slicing, lightly squeezing or grabbing the handle 20 causes cream within the dropper 30 to spout out from the distal end of the second region 32 and out from the openings 17 of the blade 10 through the cavity 16. The outward spurting of the cream is generally carried out synchronously with the slicing of the white bread. To uniformly spread the cream on the surface of the sliced white bread, the flat side 12 of the blade 10 is placed against the cream applied on the surface of the white bread. When equipped with the heating unit 50, the handle 20 preheats the cream to enhance spread ability.

After use the blade 10 and handle 20 are separated, then the dropper 30 is removed. The blade 10 and the handle 20 are magnetically coupled for easy disassembly and are easy to clean. Specifically, the dropper 30 is made of elastic material, which makes it easy to wash under running water, and keep it clean. More, the handle 20 may feature an IPX5-rated waterproof design for safe cleaning.

According to the cream spread 100 of the present invention described above, the blade 10 and the handle 20 can be detachably coupled, and the cream spread 100 includes a cream supply mechanism using a dropper 30. Thus, compared to conventional knives, the cream spread 100 of the invention improves usability. Additionally, since ach component can be disassembled, sanitary management is easy and the product can be used comfortably over a long period of time.

While the invention has been described with reference to illustrative embodiments, this description is not intended to be construed in a limiting sense. Thus, shapes, size and physical relationship of each component are roughly illustrated so the scope of the invention should not be construed to be limited to them. Further, to clarify the components of the invention, hatching is partially omitted in the cross-sectional views. Moreover, the numerical description in the embodiment described above is one of the preferred examples in the preferred embodiment so that the scope of the invention should not be construed to limit to them.

Various other modifications of the illustrated embodiment will be apparent to those skilled in the art on reference to this description.

1. A cream spread comprising:
a blade including a sharp edge, a flat side surface, and a first cavity, said blade having a plurality of through-holes on said side surface connected to said first cavity, and an opening at one end;
a handle detachably connected to said blade at said side surface, said handle including an internal second cavity, and a first opening and a second opening, each of which connects to said second cavity, wherein the handle is formed of an elastic material; and
a dropper including a first region to be inserted into said blade, and a second region to be disposed within said handle, wherein said first region protrudes from said first opening of said handle when installed in the handle.

2. A cream spread, as claimed in claim 1, further comprising:
a first magnet whose exposed surface is of a first polarity disposed on said blade at its one end; and a second magnet whose exposed surface is of a second polarity disposed adjacent to said first opening of said handle and being faced to the first magnet,
wherein the first and second magnets are mutually attracted to each other, so that said blade and the handle are detachably coupled to each other.

3. A cream spread, as claimed in claim 1, wherein said second region of said dropper is completely inserted within said first cavity of said blade.

4. A cream spread, as claimed in claim 1, wherein said first region and said second region of said dropper are integrally formed.

5. A cream spread, as claimed in claim 4, wherein said dropper is detachable through said second opening of said handle.

6. A cream spread, as claimed in claim 1, wherein said handle further including a heating unit, which includes a PTC heating plate, a thermal conductive copper plate, and an insulation layer,
wherein butter, jam, or cream is stored in said dropper, and whereby heat is transferred to said dropper to soften butter, jam, or cream for spreading it smoothly.

7. A cream spread, as claimed in claim 3, wherein said handle further including a heating unit, which includes a PTC heating plate, a thermal conductive copper plate, and an insulation layer,
wherein butter, jam, or cream is stored in said dropper, and whereby heat is transferred to said dropper to soften butter, jam, or cream for spreading it smoothly.

8. A cream spread, as claimed in claim 3, wherein said handle further including a heating unit, which includes a PTC heating plate, a thermal conductive copper plate, and an insulation layer,
wherein butter, jam, or cream is stored in said dropper, and whereby heat is transferred to said dropper to soften butter, jam, or cream for spreading it smoothly.
A cream spread, as claimed in claim 4, wherein said handle further including a heating unit, which includes a PTC heating plate, a thermal conductive copper plate, and an insulation layer,
wherein butter, jam, or cream is stored in said dropper, and whereby heat is transferred to said dropper to soften butter, jam, or cream for spreading it smoothly.

10. A cream spread, as claimed in claim 6, wherein said heating unit includes a thermal control circuit and an operation switch,
whereby heating temperature within said handle is adjustable between 30-60 Celsius.

11. A cream spread, as claimed in claim 7, wherein said heating unit includes a thermal control circuit and an operation switch,
whereby heating temperature within said handle is adjustable between 30-60 Celsius.

12. A cream spread, as claimed in claim 8, wherein said heating unit includes a thermal control circuit and an operation switch,
whereby heating temperature within said handle is adjustable between 30-60 Celsius

13. A cream spread, as claimed in claim 9, wherein said heating unit includes a thermal control circuit and an operation switch,
whereby heating temperature within said handle is adjustable between 30-60 Celsius
